(19) United States
(12) Patent Application Publication
(10) Pub. No.: US 2004/0019741 A1
(43) Pub. Date: Jan. 29, 2004

(54) Selectable internal RAID system

(76) Inventors: Thomas L. Pratt, Austin, TX (US); Raymond F. Dumbeck, Austin, TX (US)

Correspondence Address: HAMILTON & TERRILE, LLP, P.O. BOX 203518, AUSTIN, TX, 78720, US

(21) Appl. No.: 10/201,074

(22) Filed: Jul. 23, 2002

(51) Int. Cl. G06F 12/00

(52) U.S. Cl. 711/114; 711/112

(57) ABSTRACT

A storage system which includes an interface, a channel circuit coupled to the drive interface, a multiplexer, a plurality of drive heads, and a plurality of storage media. The channel circuit receives a select signal controlling whether the channel circuit functions in a single channel mode of operation or a RAID mode of operation. The multiplexer is coupled to the channel circuit and receives the select signal controlling whether the multiplexer functions in the single channel mode of operation or the RAID mode of operation. The plurality of drive heads are coupled to the multiplexer. The plurality of storage media interact with the plurality of drive heads and store data, the data being accessed by the interacting of the plurality of storage media with the plurality of drive heads.

### BACKGROUND OF THE INVENTION

1. Field of the Invention

The present invention relates to information handling systems and more particularly to disk drives for use with information handling systems.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

It is known to provide disk drive systems with RAID (Redundant Array of Independent Disks). RAID is a disk system that is used to increase performance and/or provide fault tolerance. A RAID system is a set of two or more hard disks and a RAID controller that provides the RAID functionality. Developed initially for servers and stand-alone disk storage systems, RAID systems are increasingly popular in desktop personal computers for fault tolerance and performance. However, RAID systems increase the cost of the information handling system due to the need for a RAID controller and multiple disk drives. The RAID controller may also be implemented via software only, but with less performance, especially when rebuilding data after a failure.

There are a plurality of different RAID configurations. For example, a RAID 0 configuration improves performance by disk striping, which interleaves bytes or groups of bytes across multiple drives, so more than one disk is reading and writing simultaneously. A RAID 1 configuration provides fault tolerance by mirroring. The mirroring may be 100% duplication of the data on at least two drives (RAID 1). A failed drive can be hot swapped with a new one, and the RAID controller automatically rebuilds the lost data.

One challenge associated with information handling systems relates to the performance of disk drives within the information handling system. In many information handling systems, the performance of the disk drive system is a gating factor in the performance of the overall system. To increase the performance of the disk drive system, some disk drive manufacturers use higher and higher disk rotational rates for the disks within the system. However, increasing the disk rotational rate increases the power consumption, heat dissipation and noise of the disk drive system.

### SUMMARY OF THE INVENTION

In accordance with the present invention, a disk drive system includes a drive circuit which provides for switching between a single read/write channel and multiple independent read/write channels so that a RAID function is implemented internal to the drive system.

In one embodiment, the invention relates to a storage system which includes an interface, a channel circuit coupled to the drive interface, a multiplexer, a plurality of drive heads, and a plurality of storage media. The channel circuit receives a select signal controlling whether the channel circuit functions in a single channel mode of operation or a RAID mode of operation. The multiplexer is coupled to the channel circuit and receives the select signal controlling whether the multiplexer functions in the single channel mode of operation or the RAID mode of operation. The plurality of drive heads are coupled to the multiplexer. The plurality of storage media interact with the plurality of drive heads and store data, the data being accessed by the interacting of the plurality of storage media with the plurality of drive heads.

In another embodiment, the invention relates to an information handling system which includes a processor, a memory coupled to the processor, and a disk drive system coupled to the processor and the memory. The disk drive system includes a drive interface, a channel circuit coupled to the drive interface, a multiplexer coupled to the channel circuit, a plurality of drive heads coupled to the multiplexer, and a plurality of storage media. The channel circuit receives a select signal controlling whether the channel circuit functions in a single channel mode of operation or a RAID mode of operation. The multiplexer receives the select signal controlling whether the multiplexer functions in the single channel mode of operation or the RAID mode of operation. The plurality of storage media interact with the plurality of drive heads to store data, the data being accessed by the interacting of the plurality of storage media with the plurality of drive heads.

In another embodiment, the invention relates to a disk drive system which includes an array controller and a plurality of a drives coupled to the array controller. Each of the plurality of disk drives includes a drive interface, a channel circuit coupled to the drive interface, a multiplexer coupled to the channel circuit, a plurality of drive heads coupled to the multiplexer, and a plurality of storage media interacting with the plurality of drive heads. The channel circuit receives a select signal controlling whether the channel circuit functions in a single channel mode of operation or a RAID mode of operation. The multiplexer receives the select signal controlling whether the multiplexer functions in the single channel mode of operation or the RAID mode of operation. The plurality of storage media store data, the data being accessed by the interacting of the plurality of storage media plurality of drive heads. The plurality of disk drives are controlled to provide a RAID function by the array controller.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a system block diagram of an information handling system having a disk drive system in accordance with the present invention.

FIG. 2 shows a block diagram of a disk drive system in accordance with the present invention.

FIG. 3 shows a block diagram of a read/write channel of a disk drive system of FIG. 2.

FIG. 4 shows a block diagram of an alternate disk drive system in accordance with the present invention.

### DETAILED DESCRIPTION

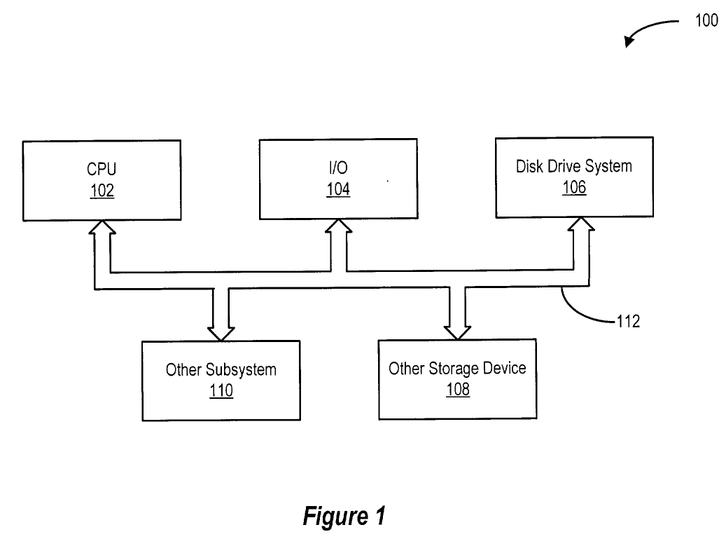

Referring to FIG. 1, a system block diagram of an information handling system 100 is shown. The information handling system 100 includes a processor 102, input/output (I/O) devices 104, such as a display, a keyboard, a mouse, and associated controllers, a disk drive system 106, and other storage devices 108, such as a floppy disk and drive and other memory devices, as well as various other subsystems 110, all interconnected via one or more buses, shown collectively as bus 112. The disk drive system 106 includes a selectable internal RAID feature in accordance with an aspect of the present invention.

For purposes of this invention, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Disk drive system 106 allows a single drive system to be fabricated in large quantities for better cost while allowing the manufacturer to selectively determine whether the drive will be a single channel drive or an internal RAID drive. Such a system allows a disk drive supplier to take advantage of economies of scale and feature flexibility. Additionally, such a system allows a manufacturer to choose the configuration of the disk drive system as late as possible in the manufacturing process. This choice may be made at the end of the drive manufacture, at the OEM site or even at by the end user. Allowing this choice provides a user with the ability to upgrade a drive after purchase.

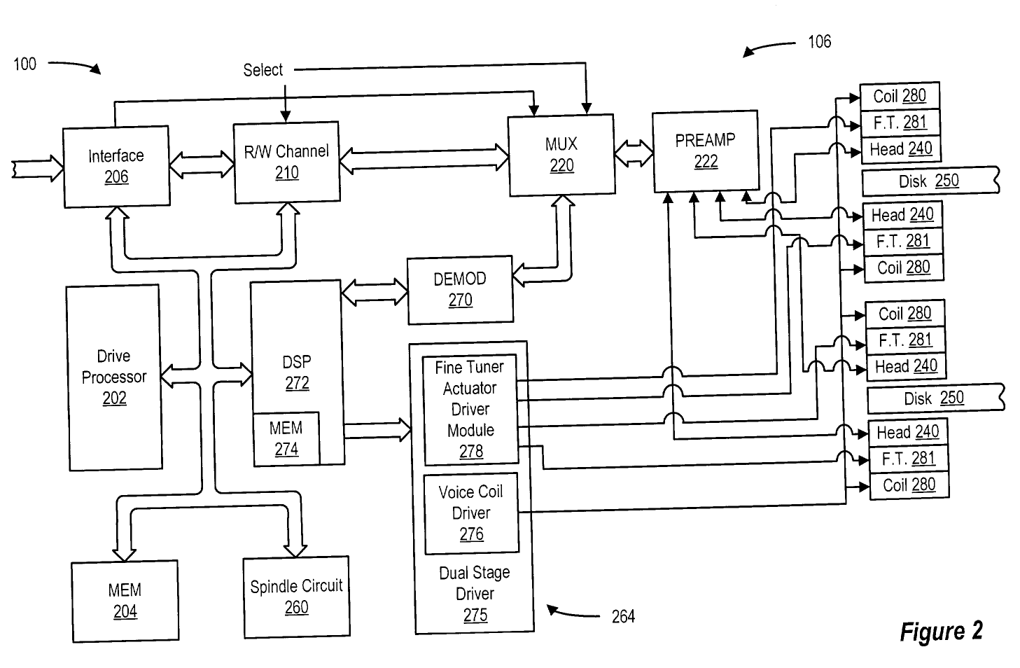

Referring now to FIG. 2, a functional block diagram of the disk drive system 106 having a selectable internal RAID function is shown; the block diagram sets forth the operational interconnection of various circuits and components. More specifically, disk drive system 106 includes a drive processor 202 which provides level control of the operation of the disk drive 106. Programming and parameter values used by the drive processor 202 are stored in drive processor memory 204 (MEM), which includes both volatile and non-volatile memory such as dynamic random access memory (DRAM) and flash memory. An interface circuit 206 includes a data buffer (not shown) for the temporary buffering transferred data, and a sequencer (not shown) which directs the operation of the disk drive system 106 during data transfer operations.

During a data write operation, the interface circuit 206 buffers and passes input data to a read/write channel 210, which encodes the data with run-length limited (RLL) and error correction codes (ECC). The encoded data are passed through a selectable multiplexer (mux) 220 to a preamp driver circuit 222 (preamp), with the mux 220 controlled by the sequencer. The preamp 222 applies write currents to the selected head 240 to selectively magnetize a portion of a corresponding storage media, such as e.g., disk platter 250. In one embodiment, the head 240 selectively magnetizes a portion of a side of a corresponding disk platter 250. Another head 240 selectively magnetizes a portion of the other side of the disk platter 250.

In one embodiment, during a data read operation previously stored data are retrieved from the disk platter 250, the preamp 222 applies a read bias current to the head 240 (e.g., in one embodiment a magneto-resistive (MR) element) and monitors the voltage across the head 240, the voltage varying with respect to the selective magnetization of the disk platter 250. The detected voltage is pre-amplified by the preamp 222 to provide an amplified read signal to the read/write channel 210, which decodes the stored data and provides the same to the buffer of the interface circuit 206 for subsequent transfer within information handling system 100.

A servo circuit 264 controls the position of each of the heads 240 with respect to the corresponding disk platters 250 in response to servo information read from the disk platters 250 and passed to the servo circuit 264 via the preamp 222 and the mux 220. The servo circuit 264 includes a demodulator (demod) 270 which conditions the servo information for use by a digital signal processor (DSP) 272 having associated programming in memory (MEM) 274. The DSP 272 provides a current command signal to a dual stage driver 275. The dual stage driver 275 includes a voice coil driver 276 and a fine tune actuator driver module 278. The voice coil driver 276 provides current to the voice coil 280 to position all of the heads 240 relative to the disk platters 250. Fine tuner actuator driver module 278 includes a plurality of individual fine tuner activator drivers corresponding to respective fine tuner actuators 281. The fine tune actuator driver module 278 provides current to individual fine tuner actuators 281 to position individual respective heads 240 relative to a respective side of a disk platter 250. While the voice coil 280 is shown separately, the voice coil is a single element.

A spindle circuit 260 rotates a spindle motor (not shown) which in turn rotates the disk platters 250.

The servo circuit 264 operates in two primary, selectable modes: seeking and track following. During a seek mode of operation, a selected head 240 is moved from an initial track to a destination track through the initial acceleration and subsequent deceleration of the head 240 toward the destination track. Once the head 240 has been settled onto the destination track, the servo circuit 144 operates in the track following mode, using the servo information to maintain the head over the destination track.

When the disk drive system 106 is operating in the single channel mode of operation, then the select signal causes the R/W channel circuit 210 and to the multiplexer 220 to operate in a single channel mode of operation.

When the disk drive system is operating in the RAID mode of operation, then the select signal causes the R/W channel circuit 210 and to the multiplexer 220 to operate in a RAID mode of operation. The R/W channel circuit 210 then functions as a RAID controller and determines which disk platter 250 to access and what data to provide to the accessed disk. Thus, if the disk drive system 106 is functioning as a RAID 0 disk drive, then data are sequentially provided to respective disk platters 250.

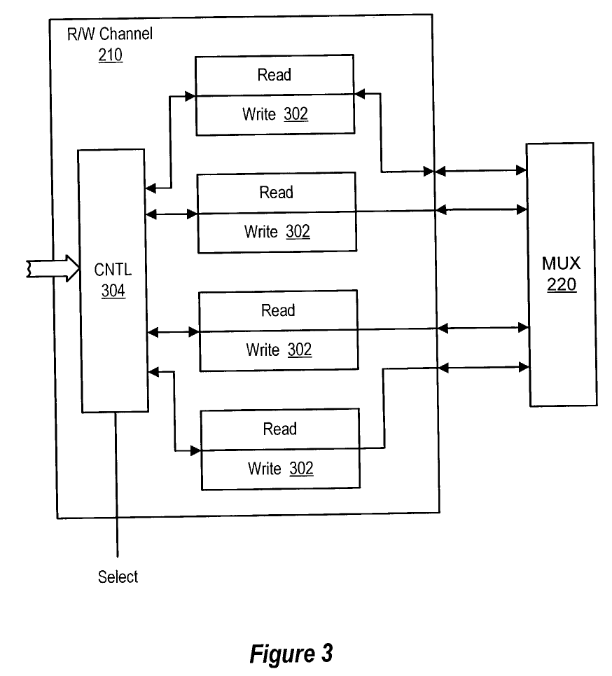

Referring to FIG. 3, read/write channel 210 includes a plurality of read/write channels 302 as well as a control circuit 304 (CNTL). Control circuit 304 enables disk drive system 106 to operate in either a single channel mode of operation or a RAID mode of operation based upon the state of the select signal. When the disk drive system 106 is operating in a signal channel mode of operation, then the control circuit 304 determines which read/write buffer to access based upon which disk platter 250 is to be accessed. When the disk drive system 106 is operating in a RAID mode of operation, then control circuit 304 functions as a RAID controller. I.e., control circuit 304 provides and receives data to and from the read/write channels so that the data are stored and retrieved in the appropriate RAID format.

For example, if the data were being stored in a RAID 0 format, the controller 304 divides the data among the four read/write channels 302 for simultaneous write to a respective disk platter 250. When reading from the disk platters 250, the controller 304 reassembles the data from the multiple disk platters 250. Also for example, if the data were being stored in a RAID 1 format, the controller 304 mirrors the same data over multiple channels 302. The controller 304 could also provide a combination of RAID 0 and RAID 1 formats.

With the combination of the read/write channel 210 and the multiplexer 220, the disk drive system 106 may be set to have a 1-to-n transfer mode, an n-to-n transfer mode, a 2-to-n transfer, etc. I.e., data from one read/write channel 302 may be sent to each disk surface via the multiplexer 220, data from each read/write channel 302 may be sent to a respective disk surface via the multiplexer 220, data from two read/write channels 302 may be sent to each disk surface via the multiplexer 220, etc.

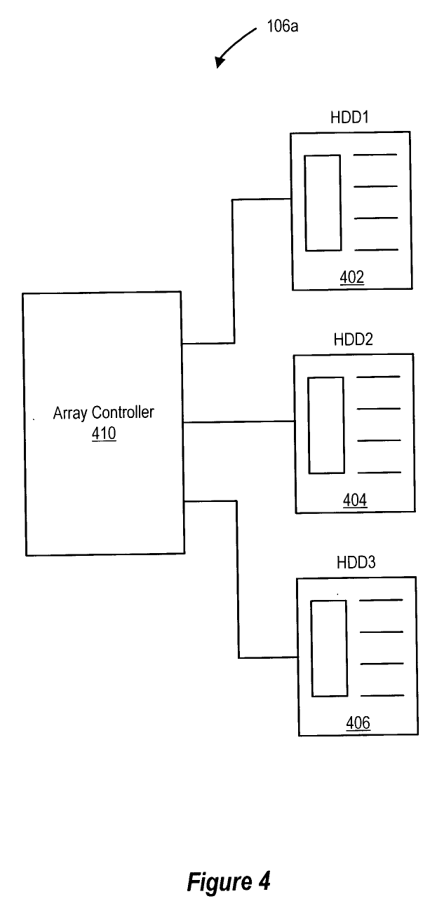

Referring to FIG. 4, a functional block diagram of a disk drive system 106a is shown. The disk drive system 106a includes a RAID system which includes a plurality of hard disc drives (HDD) 402, 404, 406 which, except as noted below, are substantially similar to a single disk drive system 106 of FIG. 2. The hard disk drives of FIG. 4 are individually identified as HDD1, HDD2 and HDD3, respectively.

The hard disc drives 402, 404, 406 are operably coupled to an array controller 408 via a common bus 410 (e.g., a bus conforming to a SCSI architecture). The array controller 410 controls the transfer of data to and from the HDD1, HDD2 and HDD3 drives 202, 204, 206 in a generally conventional manner. The array controller 410 in turn is coupled to bus 112 of the information handling system 100. Alternately, the array controller may be coupled to a network of computers which access the RAID by way of a network bus. Other types of configurations can be readily contemplated, such as a network server, mainframe computer system, etc.

Other Embodiments

Other embodiments are within the following claims.

For example, a disk drive system may be implemented to provide a combination of a single channel implementation and a RAID implementation. E.g., one disk platter of two platters is configured to function as a single channel implementation and one platter of the two platters is configured to function as a RAID implementation. Alternately, the drive system may be configured to provide a RAID 0 implementation for the inner diameter of the disk platters and a single channel implementation at the outer diameters of the disk platters to provide more uniform performance. Alternately, the drive system may be configured to provide a RAID 0 implementation in the operating system area of the disk platter to allow for faster boot.

Also for example, the disk drive system may be implemented to provide a combination of different RAID types. For example a plurality of drives could be configured such that each drive provides a redundant RAID 1 implementation, while within the drives each platter is configured to function as a RAID 0 implementation.

Also, other RAID configurations which build upon the RAID 0 and RAID 1 formats are intended to be included when describing the RAID 0 and RAID 1 formats. For example, a RAID 3 format which adds parity to a RAID 0 format is intended to be included when describing the RAID 0 format.

Also for example, the disk system may be configured as a single stage driver and actuator or other multi-independent stage drivers and actuators.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

The above-discussed embodiments include software that performs certain tasks. The software discussed herein may include script, batch, or other executable files. The software may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the software may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple software modules into a single module or may impose an alternate decomposition of functionality of modules. For example, a software module for calling sub-modules may be decomposed so that each sub-module performs its function and passes control directly to another sub-module.

What is claimed is:

1. A storage system comprising
an interface;
a channel circuit coupled to the drive interface, the channel circuit receiving a select signal controlling whether the channel circuit functions in a single channel mode of operation or a RAID mode of operation;
a multiplexer coupled to the channel circuit, the multiplexer receiving the select signal controlling whether the multiplexer functions in the single channel mode of operation or the RAID mode of operation;
a plurality of drive heads coupled to the multiplexer; and,
a plurality of storage media interacting with the plurality of drive heads, the plurality of storage media storing data, the data being accessed by the interacting of the plurality of storage media with the plurality of drive heads.

2. The disk drive system of claim 1 further comprising
a plurality of fine tuner actuators, the plurality of fine tuner actuators corresponding to the plurality of drive heads; and
a fine tuner actuator driver, the fine tuner actuator driver coupled to the plurality of fine tuner actuators.

3 The storage system of claim 1 wherein
the plurality of storage media include a plurality of disk platters

4. The storage system of claim 3 wherein
the plurality of disk platters each include a first side and a second side, and
pairs of the plurality of drive heads correspond to the first side and the second side of the disk platters.

5. The storage system of claim 1 wherein
the channel circuit and the multiplexer control determine a data transfer mode.

6. The storage system of claim 5 wherein
the data transfer mode is a 1-to-n mode, where n represents the plurality of disk surfaces.

7. The disk drive system of claim 5 wherein
the data transfer mode is an n-to-n mode, where n represents the plurality of disk surfaces.

8. An information handling system comprising
a processor;
a memory coupled to the processor; and,
a disk drive system coupled to the processor and the memory, the disk drive system including
a drive interface;
a channel circuit coupled to the drive interface, the channel circuit receiving a select signal controlling whether the channel circuit functions in a single channel mode of operation or a RAID mode of operation;
a multiplexer coupled to the channel circuit, the multiplexer receiving the select signal controlling whether the multiplexer functions in the single channel mode of operation or the RAID mode of operation;
a plurality of drive heads coupled to the multiplexer; and,
a plurality of storage media interacting with the plurality of drive heads, the plurality of storage media storing data, the data being accessed by the interacting of the plurality of storage media with the plurality of drive heads.

9. The information handling system of claim 8 wherein the disk drive system further includes
a plurality of fine tuner actuators, the plurality of fine tuner actuators corresponding to the plurality of drive heads; and
a fine tuner actuator driver module, the fine tuner actuator driver module coupled to the plurality of fine tuner actuators.

10. The information handling system of claim 8 wherein
the plurality of storage media include a plurality of disk surfaces.

11. The information handling system of claim 10 wherein
the plurality of disk platters each include a first surface and a second surface, and
pairs of the plurality of drive heads correspond to the first surface and the second surface of the disk platters.

12. The information handling system of claim 8 wherein
the channel circuit and the multiplexer control determine a data transfer mode.

13. The information handling system of claim 12 wherein
the data transfer mode is a 1-to-n mode, where n represents the plurality of disk surfaces.

14. The information handling system of claim 12 wherein
the data transfer mode is an n-to-n mode, where n represents the plurality of disk surfaces.

15. A disk drive system comprising
an array controller; and,
a plurality of a drives coupled to the array controller, each of the plurality of disk drives including
a drive interface;
a channel circuit coupled to the drive interface, the channel circuit receiving a select signal controlling whether the channel circuit functions in a single channel mode of operation or a RAID mode of operation;
a multiplexer coupled to the channel circuit, the multiplexer receiving the select signal controlling whether the multiplexer functions in the single channel mode of operation or the RAID mode of operation;
a plurality of drive heads coupled to the multiplexer; and,
a plurality of storage media interacting with the plurality of drive heads, the plurality of storage media storing data, the data being accessed by the interacting of the plurality of storage media plurality of drive heads
wherein the plurality of disk drives are controlled to provide a RAID function by the array controller.
